(19) United States
(12) Patent Application Publication
(10) Pub. No.: US 2024/0081171 A1
(43) Pub. Date: Mar. 14, 2024

(54) HOPPER LID WITH MAGNET RETENTION AND RELATED SYSTEMS AND METHODS

(71) Applicant: Ag Leader Technology, Ames, IA (US)

(72) Inventors: Nick Schwartz, Story City, IA (US); Ian Ehrecke, Ames, IA (US); Josh Cawthon, Ames, IA (US); Loren Leusink, Ames, IA (US); Alan F. Barry, Nevada, IA (US); Owen Laumbach, Ames, IA (US); Justin Pope, Ames, IA (US)

(21) Appl. No.: 18/367,929

(22) Filed: Sep. 13, 2023

Related U.S. Application Data
(60) Provisional application No. 63/406,151, filed on Sep. 13, 2022.

(51) Int. Cl. A01C 7/16; A01C 7/20

(52) U.S. Cl. CPC A01C 7/163; A01C 7/201

(57) ABSTRACT

An agricultural row unit including a large capacity seed hopper and hopper lid configured for magnetic retention of the lid. Various implementations also include a built-in support stand. The hopper lid and magnetic retention allow for one handed removal and replacement of the hopper lid, increasing overall efficiency.

### CROSS-REFERENCE TO RELATED APPLICATION(S)

This application claims the benefit under 35 U.S.C. § 119(e) to U.S. Provisional Application 63/406,151, filed Sep. 13, 2022, and entitled Hopper Lid Magnet Retention and Related Systems and Methods, which is hereby incorporated herein by reference in its entirety for all purposes.

### TECHNICAL FIELD

The disclosure relates to agricultural planters, row units, and hoppers for use therewith.

### BACKGROUND

Modern row crop planters use one of several methods to carry an adequate supply of seed to efficiently plant large numbers of acres without needing to stop frequently to obtain additional seed. One known method includes use of large capacity seed bin(s) located at a central location on the machine (planter) and a distribution system that maintains a small supply of seed in a small hopper located at each individual planter row unit. As the seed is consumed by the individual row unit seed distribution meter, the supply in the small hopper is resupplied from the centrally located seed bin(s). The seed may be transports to the seed hoppers on individual row unit from the centrally located seed bin(s) by a compressed air distribution system or a mechanical distribution system using augers, as would be understood.

While this type of seed distribution and central storage system can offer certain efficiencies, there are some drawbacks that can make a central storage and delivery seed system undesirable. For example, the weight of the seed when the central bin(s) are full is concentrated and can lead to excessive compaction in one part of the planting pass. Additionally, the distribution system for seed delivery has many parts adding cost and complexity. Another drawback to the use of central bin(s) with a distribution system is that it is difficult to mix seed varieties on a single pass of the planter.

A second known method for carrying seed on a planter is to have individual storage hoppers 2 located on each planter row unit 10, shown for example in FIGS. 1 and 2. These hoppers 2 are commonly plastic or fiberglass containers 2 with a singulating seed meter 8 located directly below the hopper 2. The capacity for these individual storage hoppers 2 is usually 1.5 to 3 bushels of seed. The smaller hopper 2 size is usually used in applications where there may be a need to apply in-furrow insecticide as the crop is planted. When in-furrow insecticide is applied a second hopper is also mounted on the planter row unit 10, normally directly behind the seed hopper 2 for carrying the insecticide.

In cases where in-furrow insecticide application is not a concern, many operators will choose to use high capacity (3 bushel) individual seed hoppers 2 for the added planting range that can be gained (extending the time before refilling the hopper). This extended time before refilling/added planting range is of added importance with the introduction of high speed planting practices, where the ability to cover more acres per hour leads to a more frequent need to refill individual seed hoppers 2. Time spent filling the seed hoppers 2 is not productive planting time, as stops for refilling as increased overall efficiency is reduced.

In all cases there are practical limits that determine the capacity of the seed hopper 2, including the width and the height of the hopper 2. If the hopper 2 width becomes too wide the hopper 2 sides and the lid may contact adjacent rows units 10 and cause damage as the individual rows units 10 move up and down during planting. If the hopper 2 height becomes too high, it may become difficult to lift a bag of seed, that weighs up to 70 pounds, and dump it into the open top of the hopper 2.

High capacity (3 bushel) hoppers 2 have various drawbacks. Current row units 10 and hoppers 2 incorporate a latch 6 that holds the hopper lid 4 in place, shown for example in FIG. 2. Opening of the hopper 2 for access to refill the hopper 2 requires a two-step process requiring (1) release of the latch 6 and (2) removal of the lid 4. These prior known row units 10 and hoppers 2 must also include a storage location for the lid 4 so it can be easily repositioned on the hopper 2 and re-attached when refilling is complete.

A second drawback associated with known high capacity hoppers 2 is the weight of the hopper 2 when filled with seed. For example, if the seed meter 8 located below the hopper 2 needs service when the hopper 2 is full or nearly full, the weight of the hopper 2 with seed is likely too much for 1 or 2 persons to easily lift to access the seed meter 8. As such, seed will need to be scooped out of the hopper 2 and placed in a secondary container so the hopper 2 can be removed safely and the seed meter 8 accessed. This slows down repair processes and may cause seed spillage and waste, reducing overall efficiency of planting operations.

There is a need for improved planter row units and particularly disclosed here improved seed hopper implementations.

### BRIEF SUMMARY

In Example 1, a seed hopper comprising a hopper body comprising a track formed in each of two longitudinal sides of the hopper body and a magnet disposed on an upper edge of a proximal side of the hopper body. The seed hopper also comprising a hopper lid comprising a lid body, a bracket attached to the lid body, a peg on each end of the bracket configured to be fitted within the track in the hopper body, and a plate on a lower side of the lid body configured to be attracted to the magnet when the hopper lid is in a closed position.

Example 2 relates to the seed hopper of any of Examples 1 and 3-10, wherein the seed hopper has an about three bushel capacity.

Example 3 relates to the seed hopper of any of Examples 1-2 and 4-10, wherein the plate is a ferrous metal plate.

Example 4 relates to the seed hopper of any of Examples 1-3 and 5-10, wherein the magnet produces a downward force on the plate and the lid body.

Example 5 relates to the seed hopper of any of Examples 1˜4 and 6-10, further comprising a handle on an upper side of the lid body.

Example 6 relates to the seed hopper of any of Examples 1-5 and 7-10, wherein the track comprises a substantially parallel portion and a ramped portion, wherein the ramped portion is configured to assist in positioning the hopper lid into the closed position from an open position.

Example 7 relates to the seed hopper of any of Examples 1-6 and 8-10, further comprising an open notch for removal of the hopper lid from the hopper body by removing the peg from the track.

Example 8 relates to the seed hopper of any of Examples 1-7 and 9-10, further comprising a vertical notch in the track wherein the pegs are configured to be positioned with the vertical notch when the seed hopper is in a propped position.

Example 9 relates to the seed hopper of any of Examples 1-8 and 10, wherein the track includes a ramped portion, a substantially parallel portion, a removal notch, and a propped positioning notch.

Example 10 relates to the seed hopper of any of Examples 1-9, further comprising a bracket fitted onto a row unit body for accepting the hopper lid when the seed hopper is in a propped position.

In Example 11, a seed hopper for an agricultural row unit comprising a hopper comprising a track formed in each of two longitudinal sides of the hopper, the track comprising a parallel portion and a ramped portion at a first end of the track and a magnet disposed at a second end of the hopper. The seed hopper also comprising a hopper lid comprising a lid body, a bracket at a first end of to the lid body, a peg on each end of the bracket wherein the pegs slide within the track as the hopper lid is moved between opened and closed positions, and a plate on a lower side of a second end of the lid body configured to be hold hopper lid in the closed position.

Example 12 relates to the seed hopper of any of Examples 11 and 13-18, wherein the plate is a ferrous metal plate.

Example 13 relates to the seed hopper of any of Examples 11-12 and 14-18, further comprising a vertical notch in the track wherein the pegs are configured to be positioned with the vertical notch when the seed hopper is in a propped position.

Example 14 relates to the seed hopper of any of Examples 11-13 and 14-18, further comprising an open notch for removal of the hopper lid from the hopper by removing the peg from the track.

Example 15 relates to the seed hopper of any of Examples 11-14 and 15-18, wherein the magnet produces a downward force on the plate and the lid body.

Example 16 relates to the seed hopper of any of Examples 11-15 and 17-18, further comprising a handle on the lid body.

Example 17 relates to the seed hopper of any of Examples 11-16 and 18, wherein the seed hopper is a high-capacity seed hopper.

Example 18 relates to the seed hopper of any of Examples 11-17, wherein the high-capacity seed hopper has an about three bushel capacity.

In Example 19, an agricultural row unit comprising a hopper comprising a track formed in each of two longitudinal sides of the hopper, the track comprising a parallel portion along the longitudinal side of the hopper, a ramped portion at a forward end of the track, and a removal notch at a rear end of the track, and a magnet disposed at the rear end of the hopper. The agricultural row unit also comprising a hopper lid comprising a lid body, a bracket attached at a forward end of to the lid body, a peg on each end of the bracket configured to be fitted within the track in the hopper, wherein the pegs slide within the track as the hopper lid is moved between opened and closed positions, and a plate on a lower side of the rear end of the lid body configured to be attracted to the magnet when the hopper lid is in the closed position.

Example 20 relates to the agricultural row unit of Example 19, further comprising a groove in a rear portion of a row unit frame configured for accepting a rear end of the hopper lid when the hopper is in a propped position.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a top perspective view of a hopper, according to one implementation.

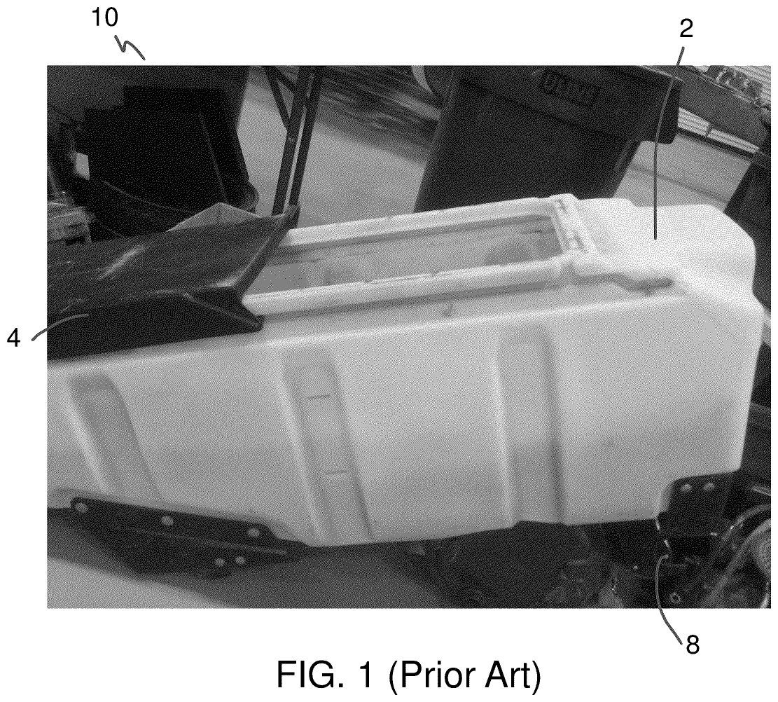

FIG. 2 is a front view of a hopper, according to one implementation.

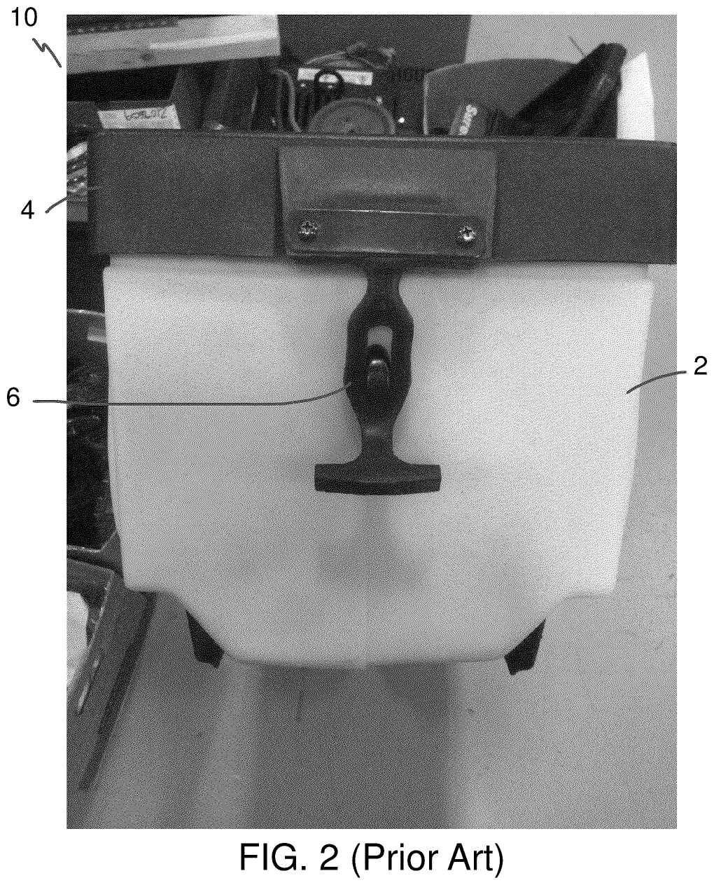

FIG. 3 is a side view of a planter, according to one implementation.

FIG. 4A is a side view of row unit, according to one implementation.

FIG. 4B is a side view of row unit, according to one implementation.

FIG. 5A is a close up side view of a front portion of a hopper, according to one implementation.

FIG. 5B is a close up side view of a front portion of a hopper, according to one implementation.

FIG. 6A is a top perspective view of a hopper, according to one implementation.

FIG. 6B is a top perspective view of a hopper, according to one implementation.

FIG. 7A is a top view of a hopper, according to one implementation.

FIG. 7B is a top view of a hopper, according to one implementation.

FIG. 8A is an underside view of a lid, according to one implementation.

FIG. 8B is an underside view of a lid, according to one implementation.

FIG. 9 is a perspective view of a row unit with hopper lid in an open position, according to one implementation.

FIG. 10A is a close up side view of a rear portion of a hopper, according to one implementation.

FIG. 10B is a close up side view of a rear portion of a hopper, according to one implementation.

FIG. 11 is a side view of a row unit with hopper in a propped position, according to one implementation.

FIG. 12 is a perspective view of a row unit with hopper in a propped position, according to one implementation.

FIG. 13A is a close up view of handle on a hopper lid, according to one implementation.

FIG. 13B is a close up view of handle on a hopper lid, according to one implementation.

### DETAILED DESCRIPTION

Disclosed herein are various planter row units and hoppers for use therewith. As noted above, hoppers, typically carrying seed, are located on individual row units to carry seeds or other item for distribution on a field during planting operations. In the case of seed hoppers, the seed hopper(s) is located above seed meter such that seed from the seed hopper is distributed to the seed meter for ultimate planting.

The various implementations of a seed hopper disclosed herein provide a hopper lid that is secure to withstand forces encountered in the field generated by rapid row unit movement during planting operations. Further, the hopper lid includes a retention devices that allows for easy, optionally one-handed, removal of the hopper lid. The quick and easy removal of the hopper lid can increase efficiency of stops for refilling hoppers with seed.

In various implementations, the hopper lid and hopper are designed to cooperate to provide a one-step removal and installation process. In the various implementations disclosed herein, the hopper and lid include a self-attaching retention mechanism that operates when the hopper lid is positioned close to its installed position. In these implementations, the user does not have to pay close attention to insure proper installation/closure of the lid.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. Pat. No. 16,523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/081,432, filed Dec. 14, 2022, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/215,721, filed Jun. 28, 2023, entitled “Seed Tube Guard and Associated Systems, Devices, and Methods of Use,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods, U.S. patent application Ser. No. 18/238,344, filed Aug. 25, 2023, entitled “Combine Yield Monitor Automatic Calibration System and Associated Devices and Methods,” U.S. Patent Application 63/427,028, filed Nov. 21, 2022, entitled “Stalk Sensors and Associated Devices, Systems and Methods,” U.S. Patent Application 63/445,960, filed Feb. 15, 2023, entitled “Ear Shelling Detection and Related Devices, Systems, and Methods,” U.S. Patent Application 63/445,550, filed Feb. 14, 2023, entitled “Liquid Flow Meter and Flow Balancer,” U.S. Patent Application 63/466,144, filed May 12, 2023, entitled “Devices, Systems, and Methods for Providing Yield Maps,” U.S. Patent Application 63/466,560, filed May 15, 2023, entitled “Devices, Systems, and Methods for Agricultural Guidance and Navigation,” U.S. Patent Application 63/524,065, filed Jun. 29, 2023, entitled “Ring Assembly,” and U.S. Patent Application 63/525,525, filed Jul. 7, 2012, entitled “Assisted Steering Systems and Associated Devices and Methods for Agricultural Vehicles,” each of which are incorporated herein by reference.

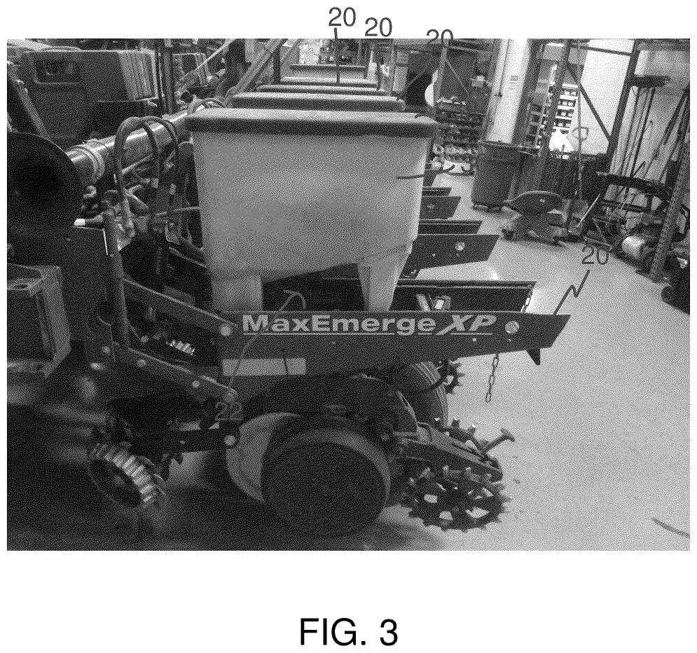

Turning to the figures in further detail, FIGS. 3-12 show various views of a row unit 20 including a seed hopper 30, optionally a high-capacity hopper 30 and associated lid 32. It would be understood, that planter row units 20 may include various additional components including but not limited to a seed meter 22, gauge wheels, opening discs, closing discs, firmers, supplemental downforce systems, row cleaners, and other devices as would be appreciated by those of skill in the art and described variously in the incorporated references. It is also understood, that planters typically include multiple, substantially identical row units 20, as shown in FIG. 3.

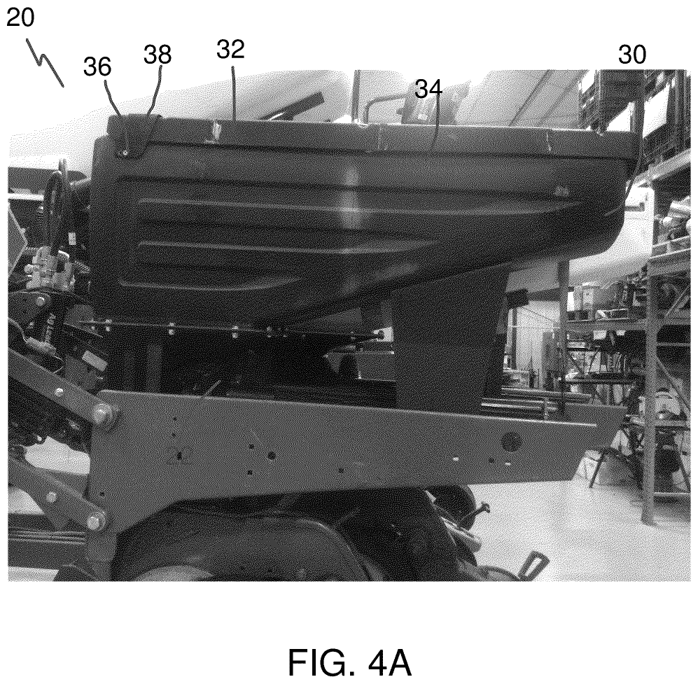

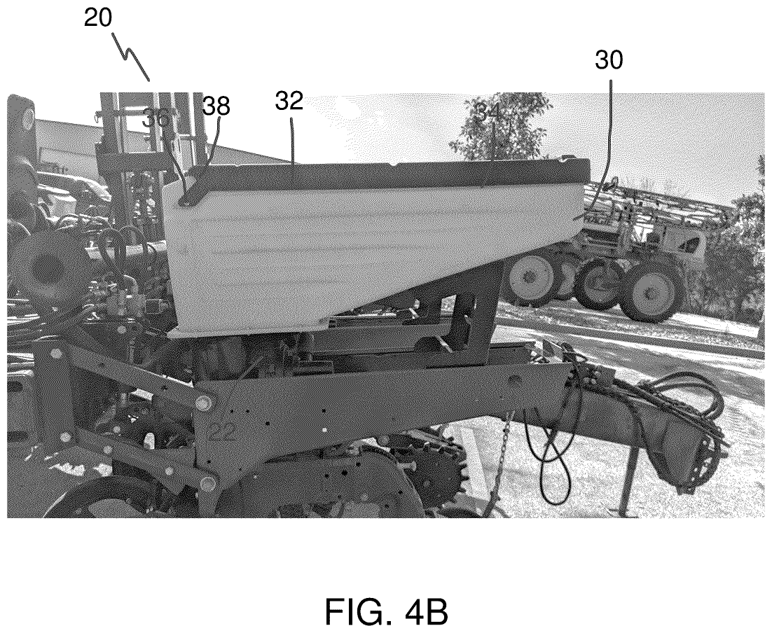

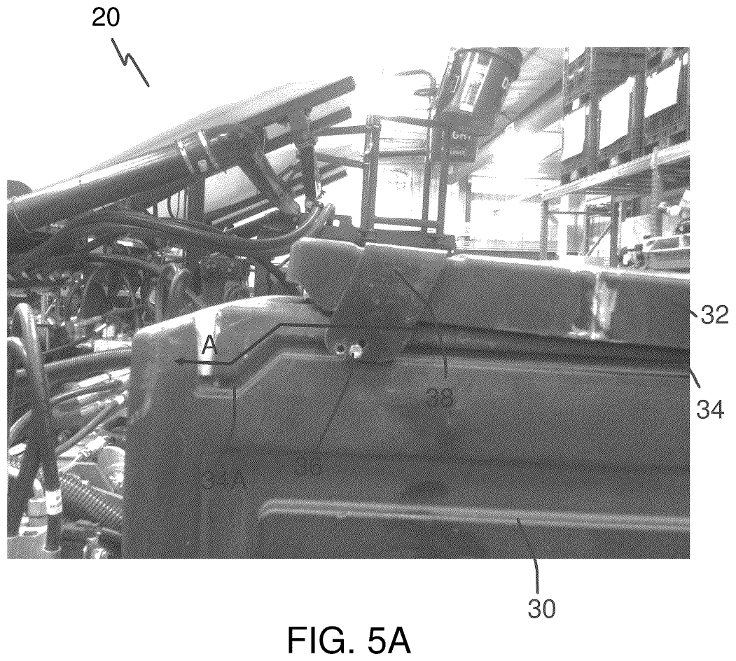

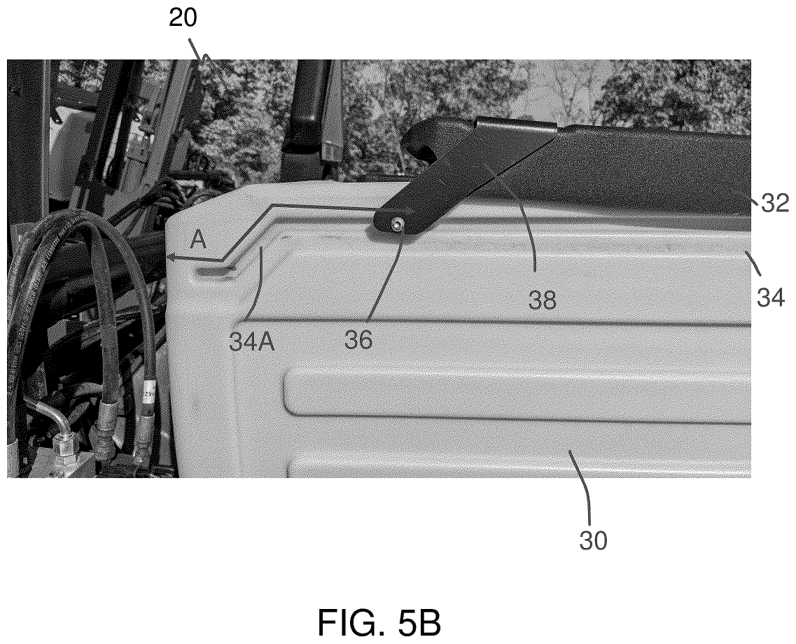

Turning to FIGS. 4A-5B, in various implementations, the hopper 30 includes a track 34 on each side that engages a peg 36 mounted to the lid 32 by a bracket 38. In these and other implementations, the shape of the track 34 causes the front of the hopper lid 32 to close tightly against the front end of the hopper 30 as the lid 32 is pushed forward. That is the peg 36 slides along the track 34 running the length of the hopper 30, and at one end of the hopper 30 the track 34 includes a shaped/contoured portion 34A causing the lid 32 to be forced into the closed position. In certain implementations, the shaped portion 34A includes a decline/ramp where gravity will pull the peg 36 forward and downward in the direction of arrow A to close the hopper 30.

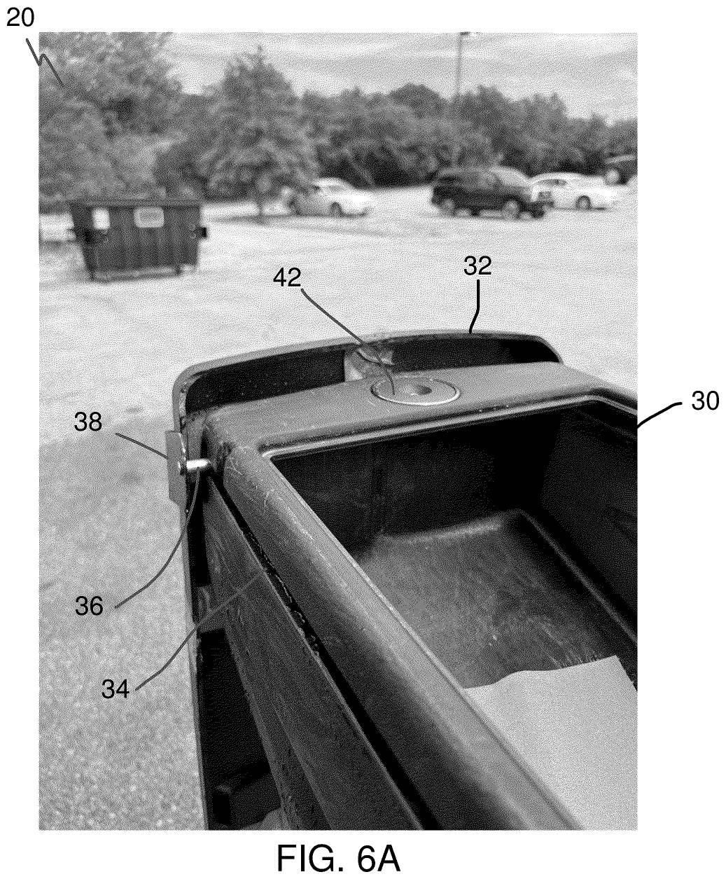

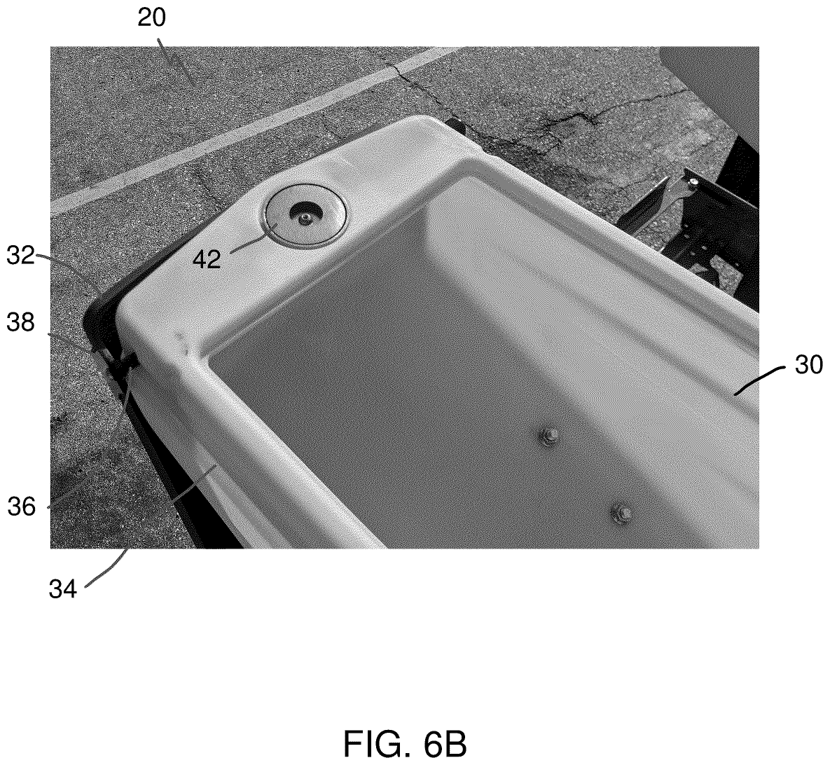

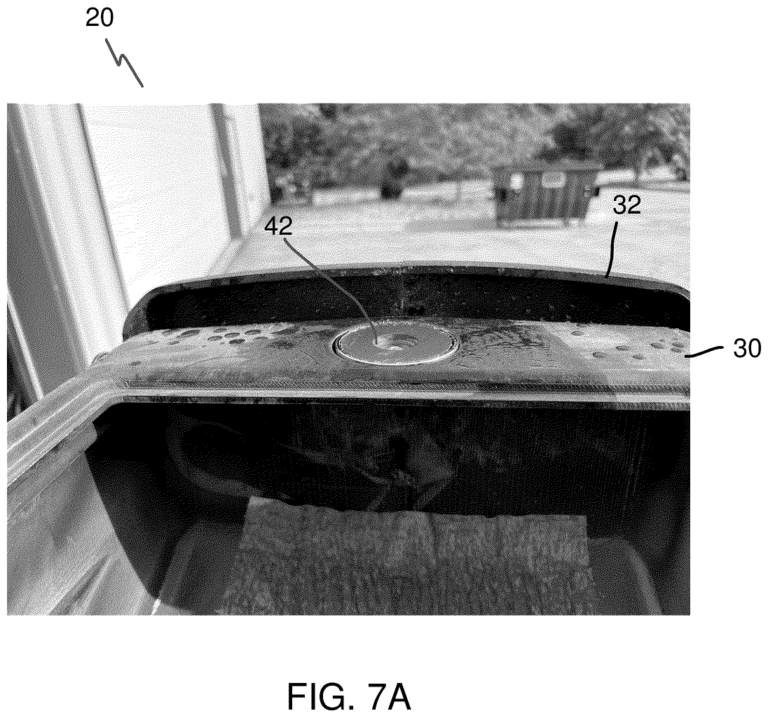

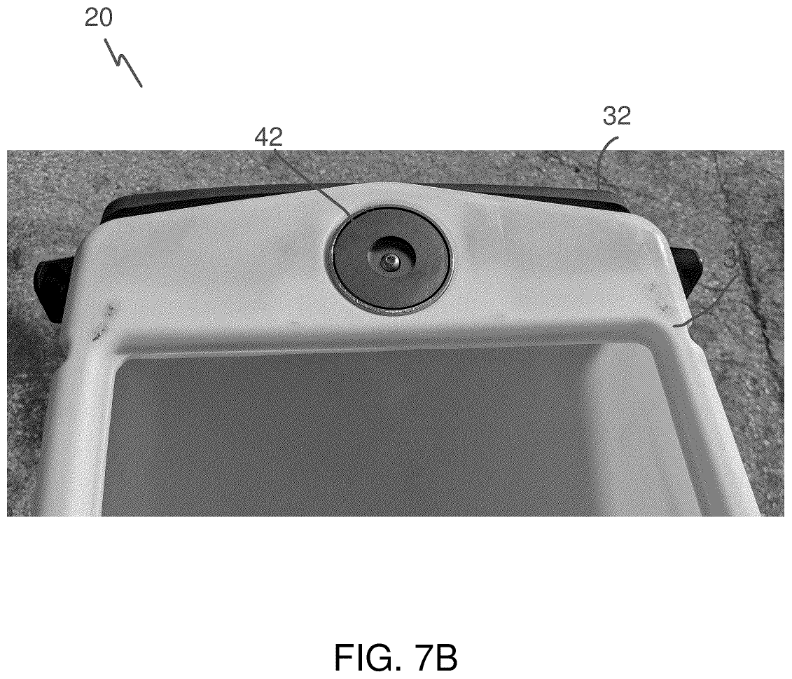

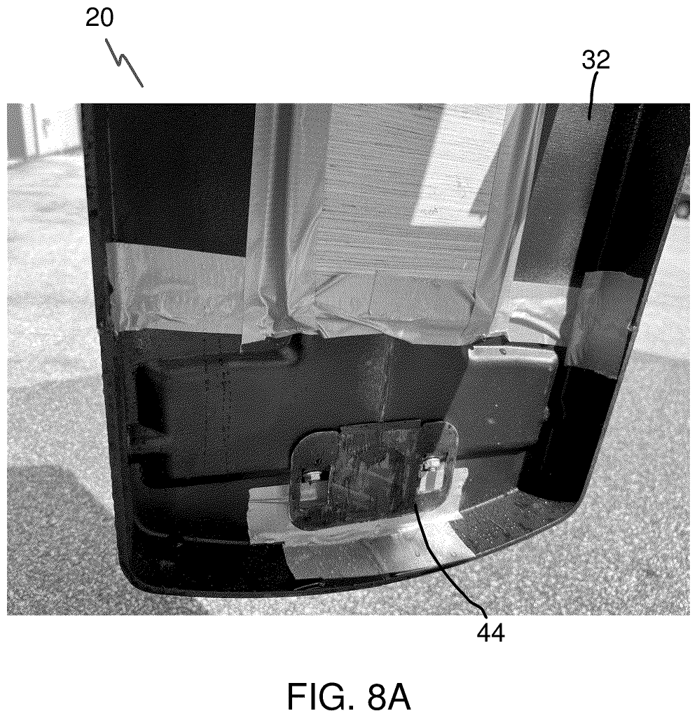

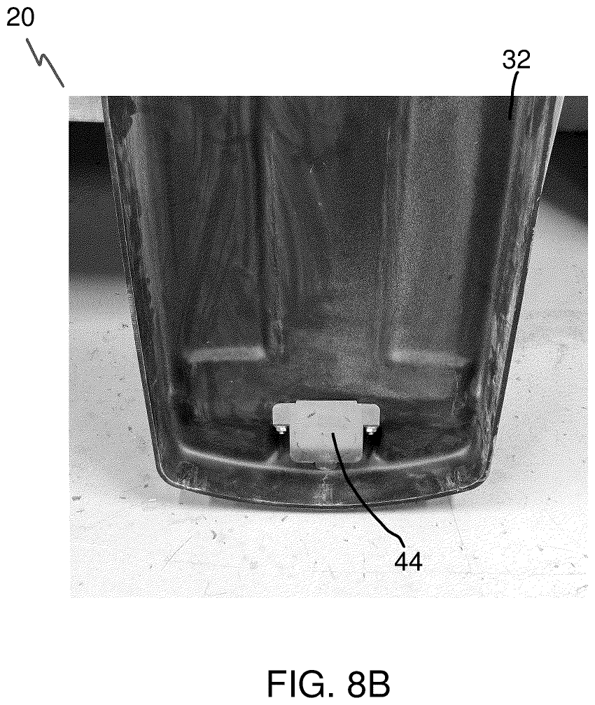

In various implementations, the hopper lid 32 is held in the closed position by a magnet 42 located in the hopper 30, shown in FIGS. 6A-7B. It would be understood that the magnet 42 attracts the lid 32 by a corresponding plate 44 attached to the inside of the lid 32, shown in FIGS. 8A-B. In various implementation, the plate 44 is a ferrous metal plate 44, or other material attracted to the magnet 42. In certain implementations the magnet 42 is located at the rear of the hopper 30, the end opposite the shaped portion 34A of the track 34, and in these implementations, the plate 44 is located at the rear of the lid 32. In various alternative implementations, the magnet 42 may be located at the front of the hopper 30, as would be understood, and the plate 44 is located at the front of the lid 32.

The magnet 42 produces a strong downward pull on the plate 44 to hold the lid 32 in the closed position. The combination of the track 34 shape and the magnet 42 pull hold the lid 32 can be held securely to the top of the hopper 30 to withstand upward and sidewards forces that may be encountered as the row unit 20 traverses terrain, including during planting operations. Further, the magnet 42 will pull the lid 32 to a closed position if the ferrous plate 44 is positioned close to the magnet 42. That is, as a user pushes the lid 32 forward (into a closed position) on the hopper 30 while closing the lid 32 the magnet 42 will pull the lid 32 into its final closed position and securely retain the lid 32 in that closed position with no additional action required from the user.

In various implementations, if upward forces on the row unit 20 and specifically the hopper 30 become great enough that they overcome the magnetic retention of the lid 32, that is the plate 44 may become detached from magnet 42. But, the lid 32 will close again on the hopper 30 when the upward force is diminished, when that the magnetic attraction of the magnet 42 on the plate 44 is again greater than the upward forces on the row unit 20. The track 34, including the shaped portion 34A also assists in holding the lid 32 in place during operation of the row unit 20.

In various implementations, the magnet 42 and ferrous metal plate 44 are positioned on the hopper 30 and lid 32, respectively, so there is a large amount of magnetic attraction in the vertical direction. In certain implementations, there is a reduced level of magnetic attraction in a horizontal (shearing) direction, facilitating sliding the lid 32 along the track 34 to open the hopper 30.

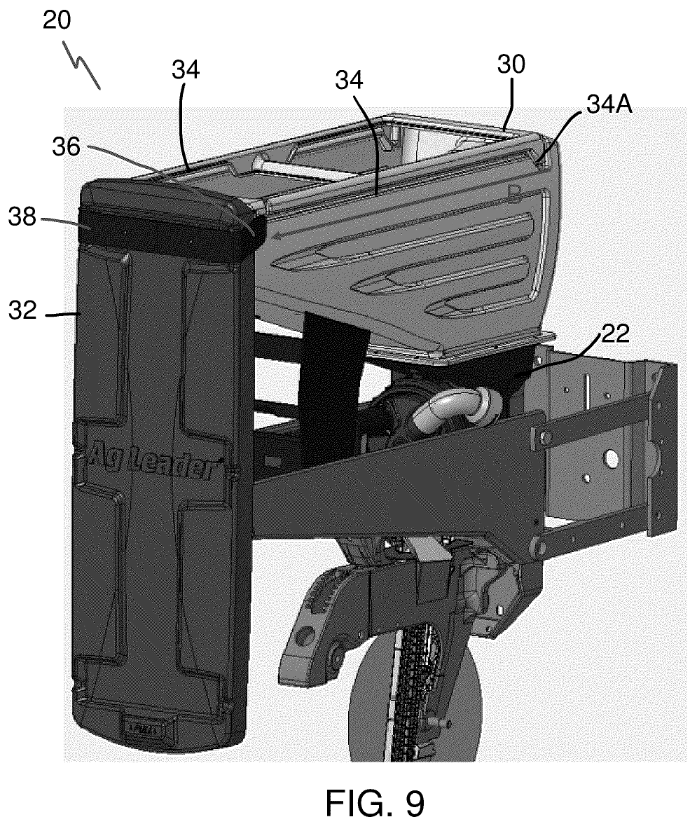

Turning to FIG. 9, in various implementations, removal of the hopper lid 32 to access the inside of the seed hopper 30 is done by applying a straight rearward force in the direction of arrow B, optionally pulling the lid 32, rather than lifting as is done with various prior art hoppers 30. As the lid 30 is forced to the rear of the row unit 20, the magnetic attraction between the plate 44 and the magnet 42 is broken. In various implementations, the shaped portion 34A of the track 34 in the hopper 30 force the front of the lid 32 to rise (sliding up the ramped portion 34A) providing clearance between the top of the hopper 30 and the underside of the lid 32. As rearward force is continued to be applied to the lid 32 the pegs 36 slide along the track 34 path until the pegs 36 are at the rear of the hopper 30. When located in this open position the lid 32 hangs from the front mounting pegs 36 vertically behind the seed hopper 30 and row unit 20 structure. In various implementations, in the open positions the front of the hopper lid 32 is located flush or below the top of the seed hopper 30 so the lid 32 is not an obstruction when a seed bag is lifted up to fill the hopper 30.

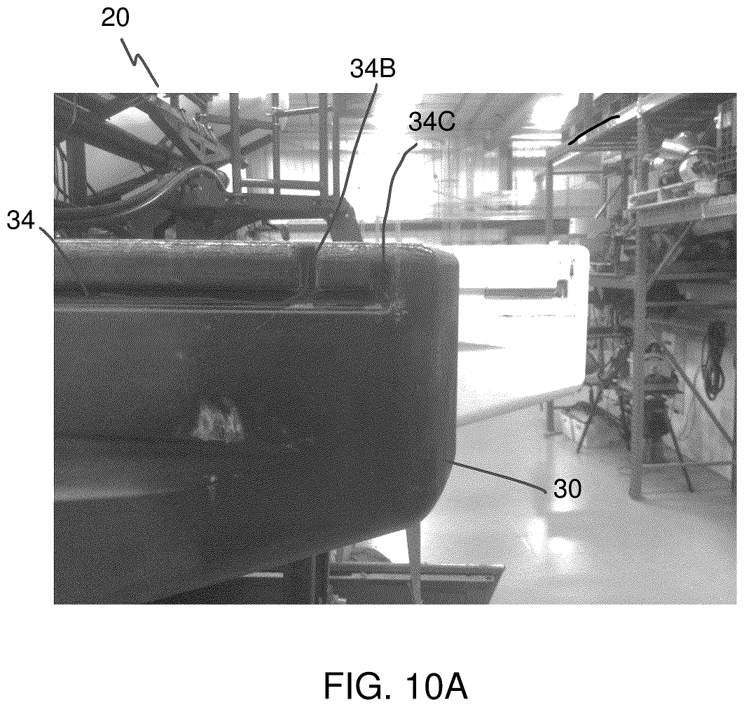

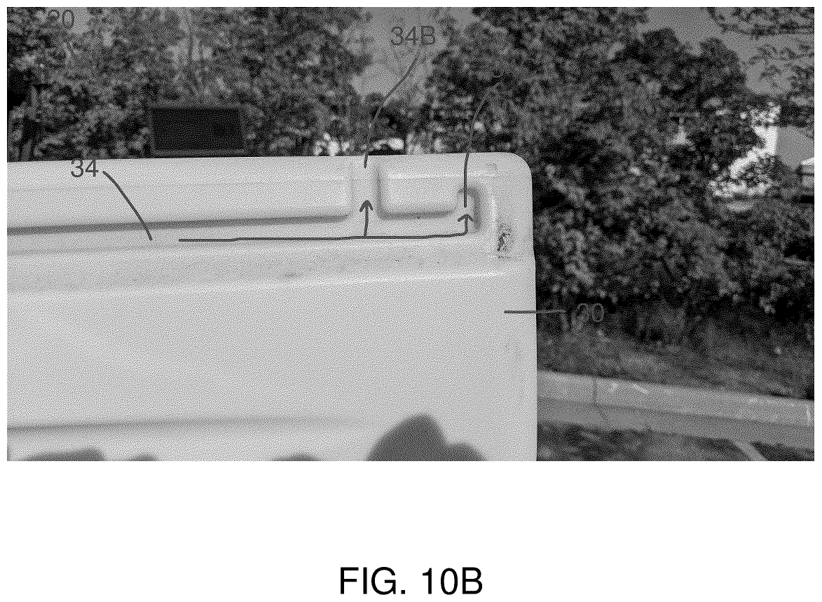

In various implementations, a secondary pathway in the hopper track 34 may be provided so the lid 32 can be completely separated from the hopper 30 if needed, shown at 34B in FIGS. 10A-B. In various implementations, the secondary pathway is an open notch 34B at a rear side/distal end of the hopper 30.

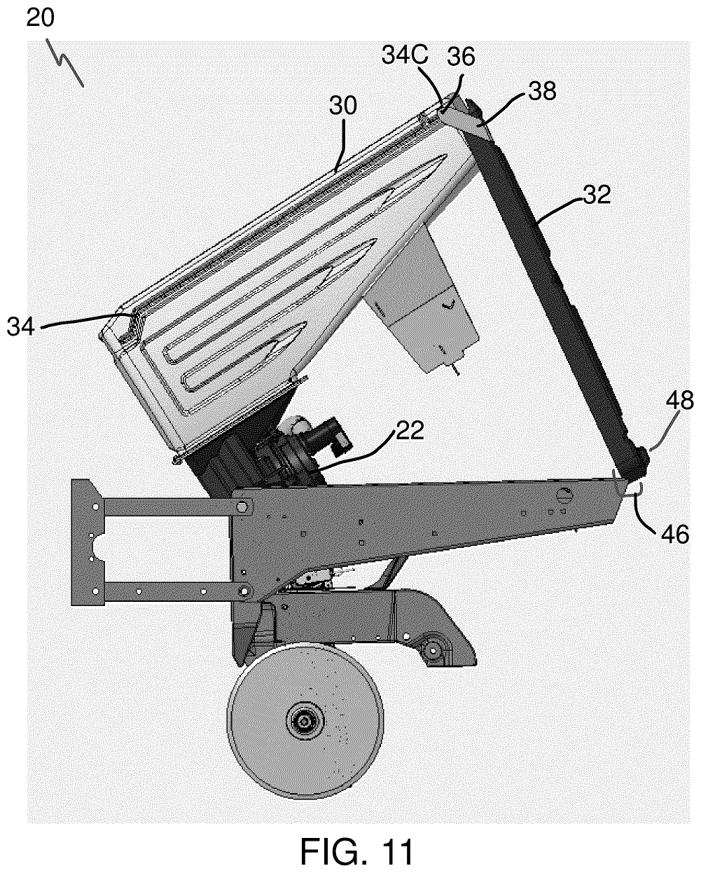

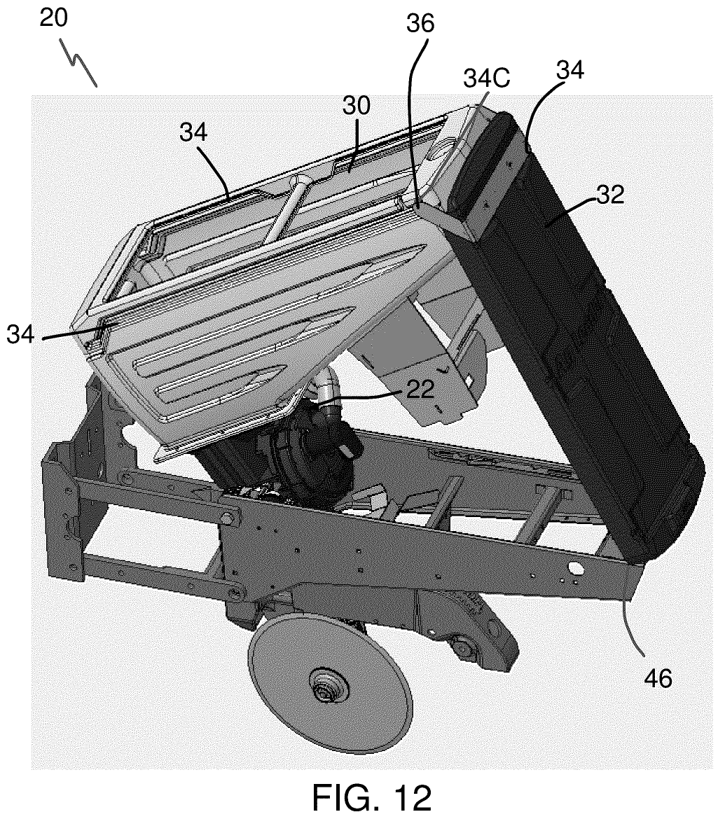

Continuing with FIGS. 9-12, in various implementations the lid 32 can be used as a prop stand for the hopper 30 When the hopper lid 32 is hanging in its storage (open hopper) position (shown in FIG. 9), a second set of short vertical pathways 34C in the hopper track 34 are provided that allow the lid 32 to be used as a support or prop stand, shown in FIGS. 11 and 12.

In various implementations, a bracket 46 attached to the planter row unit 20 to provides a positive locator for the lower end of the hopper lid 32. That is, a groove or bracket 46 may be located on the row unit 30 to position the lid 32 when the lid 32 is used as a prop stand. In use as a prop stand, the lid 32 allows the seed hopper 30, optionally full with seed, to be rotated upwards about its front mounting pivots, to provides service access to the seed meter 22. In various implementations, the angle that the hopper 30 is positioned at is sufficient to reduce the angle of repose through the seed meter 22 so that the meter cover and seed disk can be removed without any seed flow from the hopper 30, as would be appreciated.

In various implementations, the hopper 30 needs to be at or below 80% of its seed capacity so there is no spillage out of the top opening of the hopper 30 when in the propped position. While removal of seed may not be desirable the various implementations disclosed herein require removal of far less seed to remove than if it were necessary to lighten the hopper 30 enough lift it off the planter row unit 20. For example, seed for 1 bushel may weigh about 56 lbs, such that when full a high capacity hopper 30 may have a weight of three bushels, 168 lbs. The various implementations disclosed herein may optionally require that the seed capacity be at or below 80% to lift the hopper 30 into the propped positions, this would be about 135 lbs of seed.

But, for a removal as required by prior known hopper, the hopper would need to be reduced to about 50 or 60 lbs. to allow it to be easily removed from the planter row unit 20 to service the seed meter 22. In the currently disclosed implementations, as the hopper 30 is tilted forward, the center of gravity of the seed weight shifts forward over the front pivot supports so the hopper lid 32/support stand serves as a stabilizer. The hopper lid 32 in the propped position only supports a small part of the total seed weight and instead the weight is carried by the pivot supports, as would be understood.

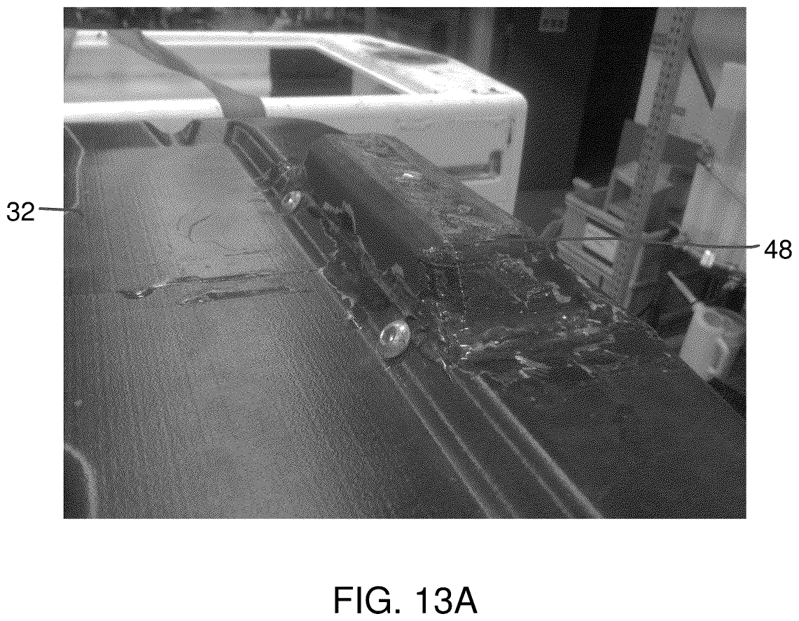

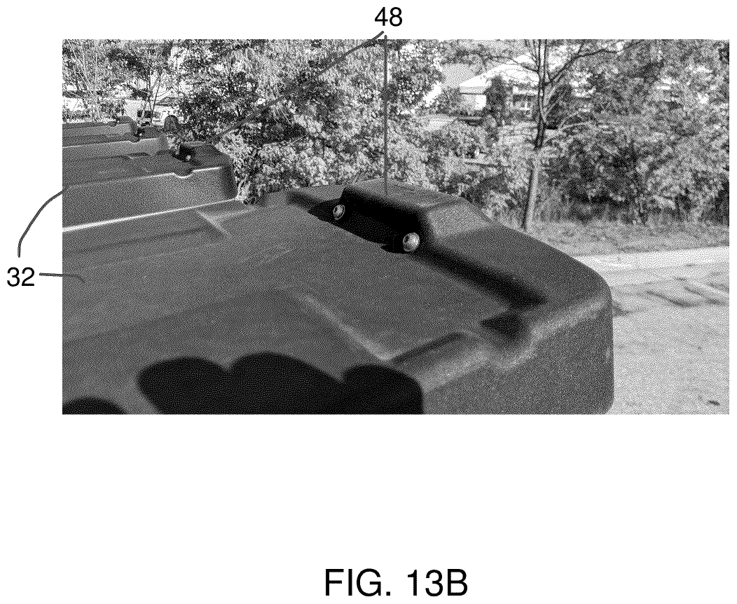

FIGS. 13A-B shows an optional handle 48 or grip 48 for facilitating applying force to the hopper lid 32. Optionally, the handle 48 is located at a rear portion of the lid 32 such that a user can apply the required rearward force to disengage the plate 44 from the magnet 42 to move the lid from the closed position to an open position.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Although the disclosure has been described with references to various embodiments, persons skilled in the art will recognize that changes may be made in form and detail without departing from the spirit and scope of this disclosure.

What is claimed is:

1. A seed hopper comprising:
(a) a hopper body comprising:
(i) a track formed in each of two longitudinal sides of the hopper body; and
(ii) a magnet disposed on an upper edge of a proximal side of the hopper body; and
(b) a hopper lid comprising:
(i) a lid body;
(ii) a bracket attached to the lid body;
(iii) a peg on each end of the bracket configured to be fitted within the track in the hopper body; and
(iv) a plate on a lower side of the lid body configured to be attracted to the magnet when the hopper lid is in a closed position.

2. The seed hopper of claim 1, wherein the seed hopper has an about three bushel capacity.

3. The seed hopper of claim 1, wherein the plate is a ferrous metal plate.

4. The seed hopper of claim 1, wherein the magnet produces a downward force on the plate and the lid body.

5. The seed hopper of claim 1, further comprising a handle on an upper side of the lid body.

6. The seed hopper of claim 1, wherein the track comprises a substantially parallel portion and a ramped portion, wherein the ramped portion is configured to assist in positioning the hopper lid into the closed position from an open position.

7. The seed hopper of claim 1, further comprising an open notch for removal of the hopper lid from the hopper body by removing the peg from the track.

8. The seed hopper of claim 1, further comprising a vertical notch in the track wherein the pegs are configured to be positioned with the vertical notch when the seed hopper is in a propped position.

9. The seed hopper of claim 1, wherein the track includes a ramped portion, a substantially parallel portion, a removal notch, and a propped positioning notch.

10. The seed hopper of claim 1, further comprising a bracket fitted onto a row unit body for accepting the hopper lid when the seed hopper is in a propped position.

11. A seed hopper for an agricultural row unit comprising:
(a) a hopper comprising:
(i) a track formed in each of two longitudinal sides of the hopper, the track comprising a parallel portion and a ramped portion at a first end of the track; and
(ii) a magnet disposed at a second end of the hopper; and
(b) a hopper lid comprising:
(i) a lid body;
(ii) a bracket at a first end of to the lid body;
(iii) a peg on each end of the bracket wherein the pegs slide within the track as the hopper lid is moved between opened and closed positions; and
(iv) a plate on a lower side of a second end of the lid body configured to be hold hopper lid in the closed position.

12. The seed hopper of claim 11, wherein the plate is a ferrous metal plate.

13. The seed hopper of claim 11, further comprising a vertical notch in the track wherein the pegs are configured to be positioned with the vertical notch when the seed hopper is in a propped position.

14. The seed hopper of claim 11, further comprising an open notch for removal of the hopper lid from the hopper by removing the peg from the track.

15. The seed hopper of claim 11, wherein the magnet produces a downward force on the plate and the lid body.

16. The seed hopper of claim 11, further comprising a handle on the lid body.

17. The seed hopper of claim 11, wherein the seed hopper is a high-capacity seed hopper.

18. The seed hopper of claim 17, wherein the high-capacity seed hopper has an about three bushel capacity.

19. An agricultural row unit comprising:
(a) a hopper comprising:
(i) a track formed in each of two longitudinal sides of the hopper, the track comprising:
(A) a parallel portion along the longitudinal side of the hopper;
(B) a ramped portion at a forward end of the track; and
(C) a removal notch at a rear end of the track; and
(ii) a magnet disposed at the rear end of the hopper; and
(b) a hopper lid comprising:
(i) a lid body;
(ii) a bracket attached at a forward end of to the lid body;
(iii) a peg on each end of the bracket configured to be fitted within the track in the hopper, wherein the pegs slide within the track as the hopper lid is moved between opened and closed positions; and
(iv) a plate on a lower side of the rear end of the lid body configured to be attracted to the magnet when the hopper lid is in the closed position.

20. The agricultural row unit of claim 19, further comprising a groove in a rear portion of a row unit frame configured for accepting a rear end of the hopper lid when the hopper is in a propped position.
